(19) United States
(12) Patent Application Publication
(10) Pub. No.: US 2017/0279909 A1
(43) Pub. Date: Sep. 28, 2017

(54) METHOD AND ELECTRONIC DEVICE FOR RESUMING PLAYING VIDEOS BETWEEN MULTI-TERMINALS

(71) Applicants: Le Holdings (Beijing) Co., Ltd., Beijing (CN); LE SHI INTERNET INFORMATION & TECHNOLOGY CORP., BEIJING, Beijing (CN)

(72) Inventor: Fengyang AN, Beijing (CN)

(21) Appl. No.: 15/247,088

(22) Filed: Aug. 25, 2016

Related U.S. Application Data
(63) Continuation of application No. PCT/CN2016/089046, filed on Jul. 7, 2016.

(30) Foreign Application Priority Data
Mar. 22, 2016 (CN) 201610166650.2

(51) Int. Cl. H04L 29/08; H04L 29/06

(52) U.S. Cl. CPC H04L 67/26; H04L 65/604; H04L 67/22

(57) ABSTRACT

A method for resuming playing videos between multi-terminals include: monitoring an event that a user is watching a video via a first terminal; sending an upload instruction to the first terminal; receiving a piece of play progress information of the video that is continuously uploaded at a preset time interval by the first terminal until the event that the user is watching the video via the first terminal finishes; monitoring an event that the user requests playing of the video via a second terminal; reading the piece of play progress information to determine a play stopping location where the user stops watching the video via the first terminal; and pushing video resources of the video to the second terminal starting from the play stopping location so that the second terminal resumes playing of the video from the play stopping location.

### CROSS REFERENCE TO RELATED APPLICATIONS

This application is a continuation application of International patent application No. PCT/CN2016/089046, filed on Jul. 7, 2016, which claims priority to Chinese Patent Application No. 201610166650.2, filed with the Chinese Patent Office on Mar. 22, 2016, both of which are herein incorporated by reference in their entireties.

### TECHNICAL FIELD

The present disclosure relates to the technical field of video playing, and particularly, relates to a method and an electronic device for resuming playing videos between multi-terminals.

### BACKGROUND

With the development of the video playing technology and the cloud technology, users nowadays can request playing of various video programs from network termination via a wide variety of different terminals, which brings people great convenience. However, because the terminals are located at different positions, the user may be unable to finish watching the entire video completely at one time. In this case, the user may want to watch the remaining part of the video via other terminals. For example, the user watches an episode via a vehicle-mounted terminal, and stops playing the video at the end of his/her trip, so the video stops at a middle part thereof. After the user goes back home and turns on an intelligent TV, it is desirable if the playing of the video can be resumed from the play stopping location where the user stops watching the video via the vehicle-mounted terminal.

In the related arts, the user can resume playing of a video that he/she has not finished watching on the intelligent TV or an intelligent phone, and in this case, the user needs to fast forward the video by himself/herself and adjusts the play process based on memory to find the play stopping location where he/she stops watching the video via the vehicle-mounted terminal.

### SUMMARY

A method for resuming playing videos between multi-terminals is provided in an embodiment of the present disclosure. The method includes: at an electronic device, monitoring an event that a user is watching a video via a first terminal; sending an upload instruction to the first terminal; receiving a piece of play progress information of the video that is continuously uploaded at a preset time interval by the first terminal until the event that the user is watching the video via the first terminal finishes; monitoring an event that the user requests playing of the video via a second terminal; reading the piece of play progress information to determine a play stopping location where the user stops watching the video via the first terminal; and pushing video resources of the video to the second terminal starting from the play stopping location so that the second terminal resumes playing of the video from the play stopping location.

An electronic device is provided in another embodiment of the present disclosure. The electronic device includes: at least one processor and a storage device. The storage device is communicably connected with the at least one processor for storing instructions executable by the at least one processor. Wherein execution of the instructions by the at least one processor causes the at least one processor to:

monitoring an event that a user is watching a video via a first terminal;

sending an upload instruction to the first terminal;

receiving a piece of play progress information of the video that is continuously uploaded at a preset time interval by the first terminal until the event that the user is watching the video via the first terminal finishes;

monitoring an event that the user requests playing of the video via a second terminal;

reading the piece of play progress information to determine a play stopping location where the user stops watching the video via the first terminal; and

pushing video resources of the video to the second terminal starting from the play stopping location so that the second terminal resumes playing of the video from the play stopping location.

A non-transitory computed readable storage medium is provided in still another embodiment of the present disclosure. The non-transitory computed readable storage medium stores executable instructions. Wherein when the executable instructions are executed by at least one processor causes the at least one processor to:

monitoring an event that a user is watching a video via a first terminal;

sending an upload instruction to the first terminal;

receiving a piece of play progress information of the video that is continuously uploaded at a preset time interval by the first terminal until the event that the user is watching the video via the first terminal finishes;

monitoring an event that the user requests playing of the video via a second terminal;

reading the piece of play progress information to determine a play stopping location where the user stops watching the video via the first terminal; and

pushing video resources of the video to the second terminal starting from the play stopping location so that the second terminal resumes playing of the video from the play stopping location.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart diagram of a method for resuming playing videos between multi-terminals according to an embodiment of the present disclosure.

FIG. 2 is a flowchart diagram of a method for resuming playing videos between multi-terminals according to another embodiment of the present disclosure.

FIG. 3 is a schematic structural diagram of a device for resuming playing videos between multi-terminals according to an embodiment of the present disclosure.

FIG. 4 is a schematic structural diagram of a device for resuming playing videos between multi-terminals according to another embodiment of the present disclosure.

FIG. 5 is a schematic structural diagram of a video server according to an embodiment of the present disclosure.

### DETAILED DESCRIPTION

To make the objectives, technical solutions and advantages of the present disclosure clearer, a detailed description will be further made on embodiments of the present disclosure with reference to the attach drawings.

It shall be appreciated that, all expressions employing terms such as “the first” and “the second” as used in the embodiments of the present disclosure are intended to distinguish two entities or parameters which have the same name but actually are different from each other. Therefore, the terms such as “the first” and “the second” are only for convenience of description and should not be construed as being limiting to the embodiments of the present disclosure, and this will not be further described for the subsequent embodiments.

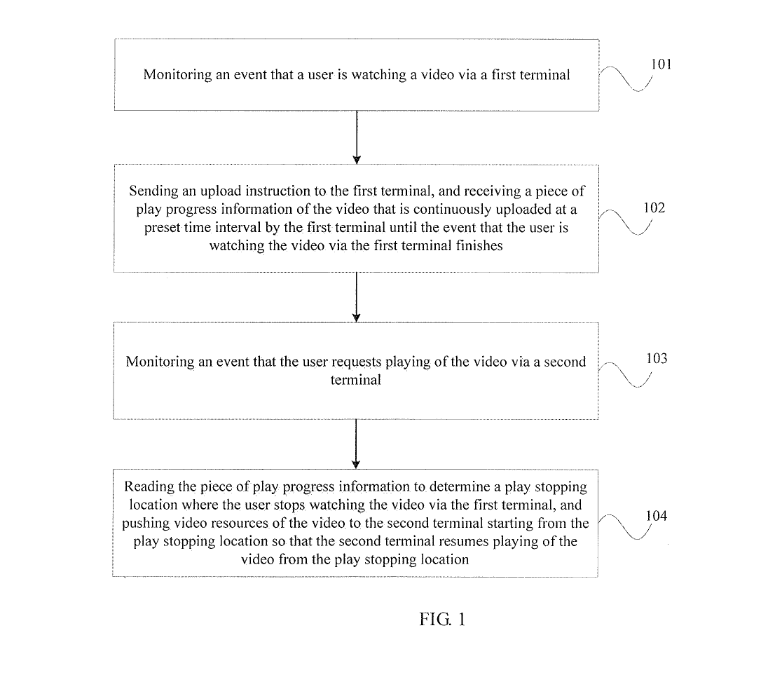

A method for resuming playing videos between multi-terminals is provided according to an embodiment of the present disclosure. FIG. 1 is a flowchart diagram of the method for resuming playing videos between multi-terminals according to an embodiment of the present disclosure.

The method for resuming playing videos between multi-terminals includes the following steps.

In Step 101: monitoring an event that a user is watching a video via a first terminal.

When a user requests playing of a certain video from a server side via a terminal, a video playing request will be sent to the server via the terminal to request the server side to push video resources and establish a video data stream, thereby finally achieving the playing of the online video on the terminal side. In this embodiment, when the video playing request sent by the user is monitored and the video data stream is finally established to start the playing of the video, it is deemed that the event that the user is watching the video via the first terminal is monitored.

In Step 102: sending an upload instruction to the first terminal, and receiving a piece of play progress information of the video that is continuously uploaded at a preset time interval by the first terminal until the event that the user is watching the video via the first terminal finishes.

In this embodiment, firstly account information of the user is checked to confirm the current user account, and then an upload instruction is sent to the first terminal to enable the first terminal to upload the play process information. The first terminal continuously uploads the play progress information of the video at a preset time interval according to the upload instruction, i.e., uploads a piece of play process information every preset time interval. The process of continuously uploading the play progress information continues until the event that the user is watching the video via the first terminal finishes, i.e., until the user closes the video.

The preset time interval may be set flexibly depending on different application environments, and generally the preset time interval is several seconds. For example, the preset time interval may be set to be 3 seconds, i.e., the play progress information uploaded by the first terminal is received every 3 seconds.

The play progress information includes: information of the current video (indicating which video the user is currently watching) and progress information (indicating the current watching progress, which may be a play time or a key frame). The received play progress information will be saved under the account of the current user for use in the subsequent steps.

Since the play progress information uploaded by the first terminal is received continuously, the play progress information is updated in an overlaying manner and then saved in this embodiment. Each time a piece of play progress information uploaded by the first terminal is received, the play progress information is enabled to overlay a piece of previously received play progress information. That is, only one piece of play progress information is saved for a video, and the piece of play progress information is the latest uploaded one.

In Step 103: monitoring an event that the user requests playing of the video via a second terminal.

In this embodiment, when it is monitored that the user sends a request for the video, that is previously watched by the user on the first terminal, via another terminal (i.e., the second terminal), it is deemed that the event that the user requests playing of the video via the second terminal is monitored.

In Step 104: reading the piece of play progress information to determine a play stopping location where the user stops watching the video via the first terminal, and pushing video resources of the video to the second terminal starting from the play stopping location so that the second terminal resumes playing of the video from the play stopping location.

In this embodiment, the play progress information of the video stored under the account of the user is read, the video resources of the video are acquired, and the video is analyzed according to the information recorded in the play progress information, thereby determining the time point or the key frame in the whole play progress of the video where the user stops watching the video via the first terminal, i.e., determining a play stopping location where the user stops watching the video via the first terminal. Then, the video resources of the video are pushed to the user from the play stopping location so that the user can resume playing of the video from the play stopping location on the second terminal.

As can he seen from the aforesaid embodiments, the method of the present disclosure saves the play progress information of a video when the user is the video via a terminal, and resumes playing of the video for the user according to the saved play progress information when the user again opens the video via other terminals. Thus, the method for resuming playing videos between multi-terminals is achieved effectively and efficiently to ensure video playing continuity between multiple terminals for the user.

In some embodiments, the method may be applied to scenarios where the user plays the video via multiple terminals such as via the vehicle-mounted terminals and terminals not mounted on the vehicle (e.g., intelligent phones and intelligent TVs or the like). That is, the user watches a video via the vehicle-mounted terminal and stops watching the video at the end of his/her trip, and thereafter, the user can continue to watch the video, which the user has not finished watching via the vehicle-mounted terminal on the vehicle, via the intelligent phone and the intelligent TV.

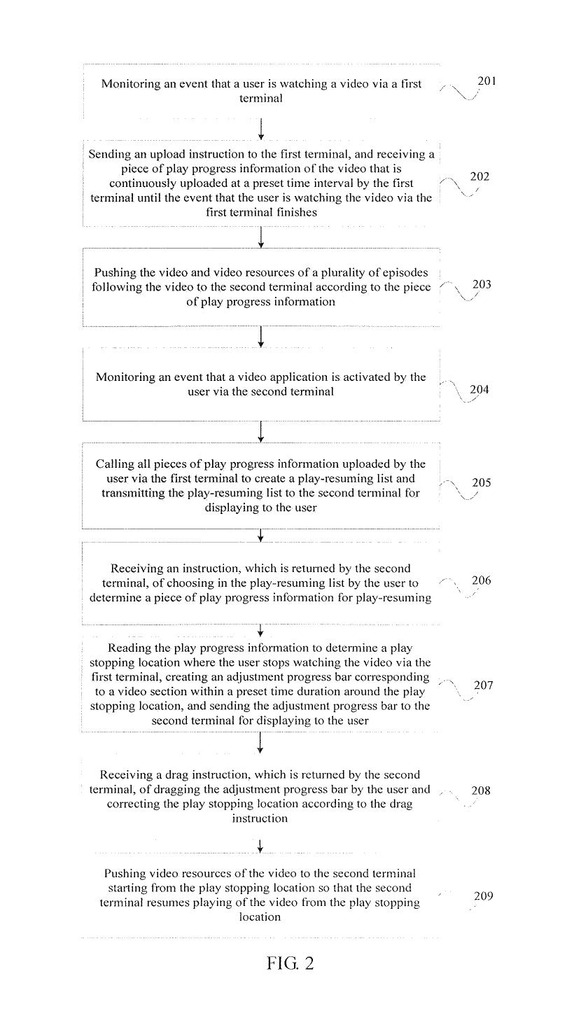

FIG. 2 is a flowchart diagram of a method for resuming playing videos between multi-terminals according to another embodiment of the present disclosure.

The method for resuming playing videos between multi-terminals includes the following steps.

In Step 201: monitoring an event that a user is watching a video via a first terminal.

In Step 202: sending an upload instruction to the first terminal, and receiving a piece of play progress information of the video that is continuously uploaded at a preset time interval by the first terminal until the event that the user is watching the video via the first terminal finishes.

In Step 203: pushing the video and video resources of a plurality of episodes following the video to the second terminal according to the piece of play progress information.

In this embodiment, the video is an episode. After the event that the user is watching the video via the first terminal finishes, it is determined which episode among a plurality of episodes the user is currently watching according to the finally stored play progress information, and then several episodes following the episode that the user is currently watching are further determined. Thereafter, video resources corresponding to the aforesaid episodes are called from a video database and then pushed to one or more other terminals (i.e., the second terminal) registered by the user.

After the episode that the user is currently watching and the following episodes are determined, the video resources of the aforesaid episodes are pushed to the second terminal in advance. In this way, when the user resumes playing of the video via the second terminal, time required for buffering the video resources are saved, thereby saving time for the user and significantly improving the user experience when the user is watching the video.

In Step 204: monitoring an event that a video application is activated by the user via the second terminal.

If the user is going to resume the playing of the previous video via the second terminal, he/she will use the video application on the second terminal, and then in this embodiment, the event that the video application is activated by the user via the second terminal is monitored.

In Step 205: calling all pieces of play progress information uploaded by the user via the first terminal to create a play-resuming list and transmitting the play-resuming list to the second terminal for displaying to the user.

In practice, the user may have watched different videos via the first terminal, so a piece of play progress information is saved for each of the videos. In this embodiment, after it is monitored that the video application is activated by the user, firstly all pieces of play progress information that are uploaded by the user via the first terminal and correspond to different videos are called, and then a play-resuming list is created according to all the play progress information and then sent to the second terminal for displaying to the user. Through the play-resuming list, all videos that have been watched by the user are shown to the user, the videos have play progress information saved therein and the playing thereof can be resumed, so the user can choose according to practical watching needs.

In Step 206: receiving an instruction, which is returned by the second terminal, of choosing in the play-resuming list by the user to determine a piece of play progress information for play-resuming,

The user chooses in the play-resuming list according to the watching need thereof, and then returns the instruction of choosing in the play-resuming list via the second terminal. According to the received instruction of choosing in the play-resuming list by the user, a piece of play progress information for play-resuming is determined from the stored several pieces of play progress information.

In Step 207: reading the play progress information to determine a play stopping location where the user stops watching the video via the first terminal, creating an adjustment progress bar corresponding to a video section within a preset time duration around the play stopping location, and sending the adjustment progress bar to the second terminal for displaying to the user.

The play progress information chosen in the play-resuming list by the user is read to determine the play stopping location where the user stops watching the video via the first terminal. Then, an adjustment progress bar is further created on the playing page according to the play stopping location. Different from the player progress bar, the adjustment progress bar only corresponds to a video section within a preset time duration around the play stopping location (i.e., a small section of video around the play stopping location) rather than corresponding to the entire video. The value of the preset time duration ranges from 1 to 3 seconds. Taking that the preset time duration is 1 second as an example, the adjustment progress bar corresponds to a video section with a length of 2 seconds around the play stopping location. The user can drag the adjustment progress bar to adjust the play stopping location.

In Step 208: receiving a drag instruction, which is returned by the second terminal, of dragging the adjustment progress bar by the user and correcting the play stopping location according to the drag instruction.

The user inputs a drag instruction of dragging the adjustment progress bar via the second terminal; after the drag instruction returned by the second terminal is received, a drag length of the drag instruction is acquired based on the drag instruction, and then a preset corresponding relationship table (which includes the corresponding relationships between the drag length and the play time duration corresponding to the drag length) is called to obtain the time duration corresponding to the drag length of the drag instruction according to the corresponding relationship table, and the play stopping location is adjusted forward or backward according to the time duration, i.e., the play stopping location get corrected.

Through the processes of step 207 and step 208, the user can further adjust the play stopping location so that the user can actively eliminate the error between the play progress information and the time point where the user actually stops watching the video that is generated during the uploading and storing process of the play progress information, thereby further ensuring the accuracy in video play-resuming.

In step 209: pushing video resources of the video to the second terminal starting from the play stopping location so that the second terminal resumes playing of the video from the play stopping location.

In this embodiment, corresponding video resources are pushed to the second terminal according to the play stopping location corrected by the user so that the second terminal resumes playing of the video for the user.

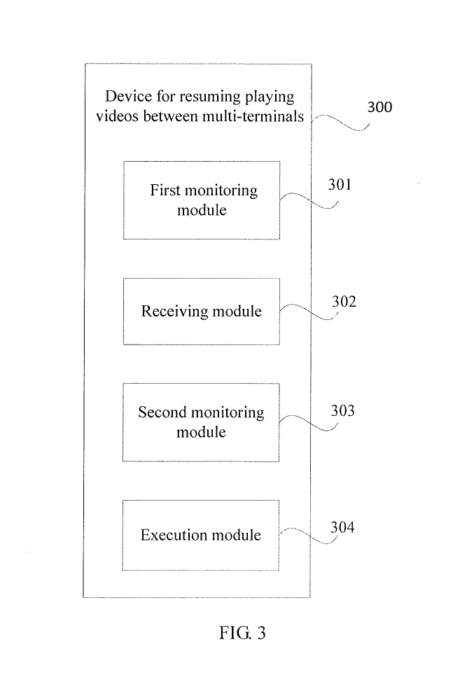

FIG. 3 is a schematic structural diagram of a device 300 for resuming playing videos between multi-terminals according to an embodiment of the present disclosure.

The device 300 for resuming playing videos between multi-terminals includes:

a first monitoring module 301 configured to monitor an event that a user is watching a video via a first terminal;

a receiving module 302 configured to send an upload instruction to the first terminal, and receive a piece of play progress information of the video that is continuously uploaded at a preset time interval by the first terminal until the event that the user is watching the video via the first terminal finishes;

a second monitoring module 303 configured to monitor an event that the user requests playing of the video via a second terminal; and

an execution module 304 configured to read the piece of play progress information to determine a play stopping location where the user stops watching the video via the first terminal, and push video resources of the video to the second terminal starting from the play stopping location so that the second terminal resumes playing of the video from the play stopping location.

As can be seen from the aforesaid embodiments, the device 300 for resuming playing videos between multi-terminals according to the embodiments of the present disclosure saves the play progress information of a video when the user is watching the video via a terminal, and resumes playing of the video for the user according to the saved play progress information when the user again opens the video via other terminals. Thus, the function of resuming playing videos between multi-terminals is achieved effectively and efficiently to ensure video playing continuity between multiple terminals for the user.

In some embodiments, the receiving module 302 is further configured to: each time a piece of play progress information uploaded by the first terminal is received, enable the play progress information to overlay a piece of previously received play progress information.

In some embodiments, the second monitoring module 303 is further configured to: monitor an event that a video application is activated by the user via the second terminal; call all pieces of play progress information uploaded by the user via the first terminal to create a play-resuming list and transmit the play-resuming list to the second terminal for displaying to the user; and receive an instruction, which is returned by the second terminal, of choosing in the play-resuming list by the user to determine a piece of play progress information for play-resuming.

In some embodiments, the execution module 304 is further configured to: create an adjustment progress bar corresponding to a video section within a preset time duration around the play stopping location and send the adjustment progress bar to the second terminal for displaying to the user; and receive a drag instruction, which is returned by the second terminal, of dragging the adjustment progress bar by the user and correcting the play stopping location according to the drag instruction.

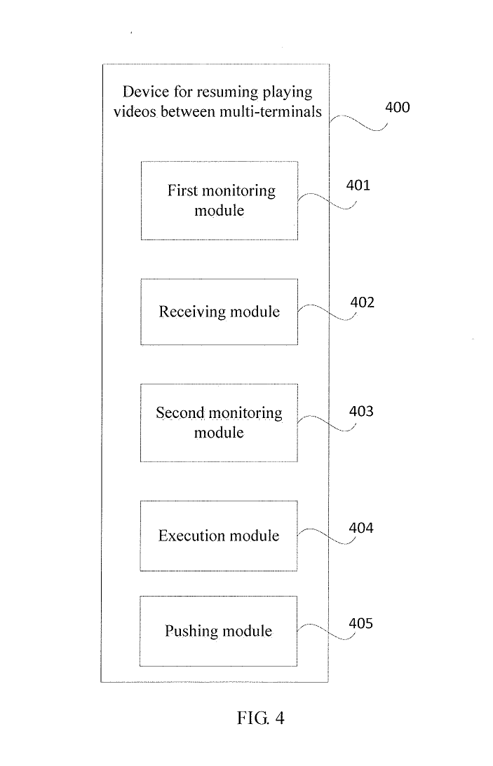

FIG. 4 is a schematic structural diagram of a device 400 for resuming playing videos between multi-terminals according to another embodiment of the present disclosure.

In this embodiment, the video is an episode, and in addition to the basic modules such as the first monitoring module 401, the receiving module 402, the second monitoring module 403 and the execution module 404, the device 400 for resuming playing videos between multi-terminals further includes a pushing module 405 that is configured to push the video and video resources of a plurality of episodes following the video to the second terminal according to the piece of play progress information.

The device 400 of the aforesaid embodiments is used for achieving the corresponding method for resuming playing videos between multi-terminals described in the aforesaid embodiments, and has the benefits achieved in the embodiments of the corresponding method, and this will not be further described herein.

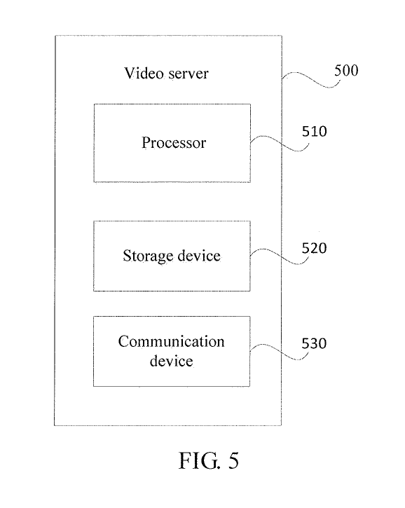

FIG. 5 is a schematic structural diagram of a video server 500 according to an embodiment of the present disclosure. The video server 500 includes: at least one processor 510, a storage device 520, and a communication device 530.

The communication device 530 is configured to be in communication with the first and second terminals.

The storage device 520 may be a non-transitory computed readable storage medium, which is configured to store computed executable program instructions. When the program instructions are executed by one or more central processors, for example, the at least one processor 510 may be caused to perform the steps in the above mentioned embodiments of the method, for example, steps 101 to 104 illustrated in FIG. 1, or steps 201 to 209 illustrated in FIG. 2. The computed executable program instructions may also be stored and/or transmitted in any non-transitory computed readable storage medium, such that these program instructions are used by an instruction executing system, apparatus or device, or used in combination with the instruction executing system, apparatus or device. The instruction executing system, apparatus or device may be, for example, a computer-based system, a system including a processor or another system capable of acquiring program instructions from the instruction executing system, apparatus or device and executing the program instructions. For the purpose of this specification, the “non-transitory computed readable storage medium” may be any tangible medium including or storing computed executable program instructions. The computed executable program instructions may be used by the instruction executing system, apparatus or device, or used in combination with the executing system, apparatus or device. The non-transitory computed readable storage medium may include, but not limited to, a magnetic, optical and/or semiconductor storage device. Examples of these storage devices include a magnetic disk, an optical disc based on CD, DVD and Blu-ray technology, and permanent solid memory (for example, a flash memory, a solid driver and the like).

In one embodiment, the device 300 of FIG. 3, as mentioned above, may be a computed software program device, the modules 301-304 are computed software program modules, stored in the storage device 520, and executed by the processor 510 to achieve the function of each module when in working. Similarly, the device 400 of FIG. 4, as mentioned above, may be a computed software program device, the modules 401-405 are also computed software program modules, stored in the storage device 520, and executed by the processor 510 to achieve the function of each module when in working.

It should be understood that in the embodiments of the present application, the processor 510 may be a central processing unit (CPU). The processor 510 may be a general processor, a digital signal processor (DSP), an application specific integrated circuit (ASIC), a field programmable gate array (FPGA) or another programmable logic device, a discrete gate or transistor logic device, or a discrete hardware component. The general processor may be a microprocessor or any customary processor or the like.

In the embodiments of the present invention, the video server 500 is not limited to the components and configurations as illustrated in FIG. 5, but may further include other or additional components having a plurality of configurations.

During the implementation, various steps in the above method and various modules in the above devices may be implemented by means of an integrated logic circuit in the processor 510 or by means of software. The steps in the method and the modules in the above devices disclosed in the embodiments of the present invention may be directly embodied as being implemented by a hardware processor, or implemented by a combination of hardware in the processor and other software modules. The software module may be located in a random memory, a flash memory, a read-only memory, a programmable read-only memory, an electrically erasable programmable memory, a register or the like storage medium commonly known in the art. The storage medium is located in the storage device 520. The processor 510 reads the information stored in the storage device 520 and performs the steps of the above method in combination with the hardware thereof. For brevity of description, the details are not given herein any further.

As shall be appreciated by those of ordinary skill in the art, the above discussion of any embodiments is only illustrative and is not intended to imply that the scope (including the claims) of the present disclosure is limited to these examples; and within the spirits of the present disclosure, technical features of the above embodiments or different embodiments may be combined with each other, the steps may be achieved in any sequence, and there are many other variations in different aspects of the present disclosure described above, although they are not detailed for purpose of simplicity.

Embodiments of the present disclosure are intended to cover all such replacements, modifications and variations falling within the broad scope of the attached claims. Accordingly, any omissions, modifications, equivalent replacements, and alterations within the spirits and principles of the present disclosure shall be included in the scope of the present disclosure.

What is claimed is:

1. A method for resuming playing videos between multi-terminals, comprising:
at an electronic device;
monitoring an event that a user is watching a video via a first terminal;
sending an upload instruction to the first terminal;
receiving a piece of play progress information of the video that is continuously uploaded at a preset time interval by the first terminal until the event that the user is watching the video via the first terminal finishes;
monitoring an event that the user requests playing of the video via a second terminal;
reading the piece of play progress information to determine a play stopping location where the user stops watching the video via the first terminal; and
pushing video resources of the video to the second terminal starting from the play stopping location so that the second terminal resumes playing of the video from the play stopping location.

2. The method according to claim 1, wherein after receiving a piece of play progress information of the video that is continuously uploaded at a preset time interval by the first terminal until the event that the user is watching the video via the first terminal finishes, the method further comprises:
pushing the video and video resources of a plurality of episodes following the video to the second terminal according to the piece of play progress information.

3. The method according to claim 1, wherein receiving a piece of play progress information of the video that is continuously uploaded at a preset time interval by the first terminal until the event that the user is watching the video via the first terminal finishes comprises:
each time a piece of play progress information uploaded by the first terminal is received, enabling the play progress information to overlay a piece of previously received play progress information.

4. The method according to claim 1, wherein monitoring an event that the user requests playing of the video via a second terminal comprises:
monitoring an event that a video application is activated by the user via the second terminal;
calling all pieces of play progress information uploaded by the user via the first terminal to create a play-resuming list and transmitting the play-resuming list to the second terminal for displaying to the user; and
receiving an instruction, which is returned by the second terminal, of choosing in the play-resuming list by the user to determine a piece of play progress information for play-resuming.

5. The method according to claim 1, wherein after reading the piece of play progress information to determine a play stopping location where the user stops watching the video via the first terminal, the method further comprises:
creating an adjustment progress bar corresponding to a video section within a preset time duration around the play stopping location;
sending the adjustment progress bar to the second terminal for displaying to the user; and
receiving a drag instruction, which is returned by the second terminal, of dragging the adjustment progress bar by the user and correcting the play stopping location according to the drag instruction.

6. An electronic device, comprising:
at least one processor; and
a storage device communicably connected with the at least one processor for storing instructions executable by the at least one processor, wherein execution of the instructions by the at least one processor causes the at least one processor to:
monitor an event that a user is watching a video via a first terminal;
send an upload instruction to the first terminal;
receive a piece of play progress information of the video that is continuously uploaded at a preset time interval by the first terminal until the event that the user is watching the video via the first terminal finishes;
monitor an event that the user requests playing of the video via a second terminal;
read the piece of play progress information to determine a play stopping location where the user stops watching the video via the first terminal; and
push video resources of the video to the second terminal starting from the play stopping location so that the second terminal resumes playing of the video from the play stopping location.

7. The electronic device according to claim 6, wherein after receiving a piece of play progress information of the video that is continuously uploaded at a preset time interval by the first terminal until the event that the user is watching the video via the first terminal finishes, execution of the instructions by the at least one processor further causes the at least one processor to:
push the video and video resources of a plurality of episodes following the video to the second terminal according to the piece of play progress information.

8. The electronic device according to claim 6, wherein receiving a piece of play progress information of the video that is continuously uploaded at a preset time interval by the first terminal until the event that the user is watching the video via the first terminal finishes comprises:
each time a piece of play progress information uploaded by the first terminal is received, enabling the play progress information to overlay a piece of previously received play progress information.

9. The electronic device according to claim 6, wherein monitoring an event that the user requests playing of the video via a second terminal comprises:
monitoring an event that a video application is activated by the user via the second terminal;
calling all pieces of play progress information uploaded by the user via the first terminal to create a play-resuming list and transmitting the play-resuming list to the second terminal for displaying to the user; and
receiving an instruction, which is returned by the second terminal, of choosing in the play-resuming list by the user to determine a piece of play progress information for play-resuming.

10. The electronic device according to claim 6, wherein after reading the piece of play progress information to determine a play stopping location where the user stops watching the video via the first terminal, execution of the instructions by the at least one processor further causes the at least one processor to:
creat an adjustment progress bar corresponding to a video section within a preset time duration around the play stopping location;
send the adjustment progress bar to the second terminal for displaying to the user; and
receive a drag instruction, which is returned by the second terminal, of dragging the adjustment progress bar by the user and correcting the play stopping location according to the drag instruction.

11. A non-transitory computed readable storage medium storing executable instructions, wherein when the executable instructions are executed by at least one processor causes the at least one processor to:
monitor an event that a user is watching a video via a first terminal;
send an upload instruction to the first terminal;
receive a piece of play progress information of the video that is continuously uploaded at a preset time interval by the first terminal until the event that the user is watching the video via the first terminal finishes;
monitor an event that the user requests playing of the video via a second terminal;
read the piece of play progress information to determine a play stopping location where the user stops watching the video via the first terminal; and
push video resources of the video to the second terminal starting from the play stopping location so that the second terminal resumes playing of the video from the play stopping location.

12. The non-transitory computed readable storage medium according to claim 11, wherein after receiving a piece of play progress information of the video that is continuously uploaded at a preset time interval by the first terminal until the event that the user is watching the video via the first terminal finishes, when the executable instructions are executed by at least one processor further causes the at least one processor to:
push the video and video resources of a plurality of episodes following the video to the second terminal according to the piece of play progress information.

13. The non-transitory computed readable storage medium according to claim 11, wherein receiving a piece of play progress information of the video that is continuously uploaded at a preset time interval by the first terminal until the event that the user is watching the video via the first terminal finishes comprises:
each time a piece of play progress information uploaded by the first terminal is received, enabling the play progress information to overlay a piece of previously received play progress information.

14. The non-transitory computed readable storage medium according to claim 11, wherein monitoring an event that the user requests playing of the video via a second terminal comprises:
monitoring an event that a video application is activated by the user via the second terminal;
calling all pieces of play progress information uploaded by the user via the first terminal to create a play-resuming list and transmitting the play-resuming list to the second terminal for displaying to the user; and
receiving an instruction, which is returned by the second terminal, of choosing in the play-resuming list by the user to determine a piece of play progress information for play-resuming.

15. The non-transitory computed readable storage medium according to claim 11, wherein after reading the piece of play progress information to determine a play stopping location where the user stops watching the video via the first terminal, when the executable instructions are executed by at least one processor further causes the at least one processor to:
create an adjustment progress bar corresponding to a video section within a preset time duration around the play stopping location;
send the adjustment progress bar to the second terminal for displaying to the user; and
receive a drag instruction, which is returned by the second terminal, of dragging the adjustment progress bar by the user and correcting the play stopping location according to the drag instruction.
